(19) United States
(12) Patent Application Publication
(10) Pub. No.: US 2007/0041562 A1
(43) Pub. Date: Feb. 22, 2007

(54) Inter campaign and queue cooperation

(76) Inventor: Martin Lachapelle Bernier, Boucherville (CA)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(21) Appl. No.: 11/204,619

(22) Filed: Aug. 16, 2005

(51) Int. Cl. H04M 3/00

(52) U.S. Cl. 379/265.01

(57) ABSTRACT

Generally, the invention is a device, method, and system for transferring a communication session from a first outbound campaign to a second outbound campaign. The first outbound campaign may include a first communication initiating device and a first set of outbound agent communication terminals. The second outbound campaign may include a second communication initiating device and a second set of outbound agent communication terminals. The system places at least one outbound communication to a customer using the first communication initiating device of the first communication campaign. The system connects the outbound communication to an available outbound agent of the first outbound campaign. The system determines if the customer needs to be connected to an outbound agent terminal of the second outbound campaign and transfers the customer to the outbound agent of the second outbound campaign.

### TECHNICAL FIELD

The present invention relates to a contact center and more particularly, to a device, method, and system for transferring customers from a first outbound contact platform to a second outbound contact platform.

### BACKGROUND INFORMATION

Contact centers place telephone calls, textual chats, email, and other methods of communications (hereinafter collectively referred to as “communications”) to customers. Customers may include current customers, previous customers, and individuals with information or with a desire to obtain additional information. The outbound platforms typically include an automated dialing system for contacting the customer. The automated dialing system is supplied with contact information for a list of customers associated with a campaign. When the automated dialing system reaches a busy number or unavailable customer, the communication session may be terminated and contacted again at a later time. When the automated dialing system reaches a live customer, the automated dialing system connects the live customer to an agent within a group of agents assigned to the campaign. The agent communicates the necessary information to the customer. Once the agent and customer have completed the communication session, the communication may be terminated and the agent is connected to the next live customer provided by the automated dialing system.

A growing number of businesses have begun using contact centers to handle interactions between customers by way of telephone and/or other communication modes. Companies typically use contact center services, for example, to manage outbound communications campaigns to potential customers for telemarketing or to existing customers for collections information or customer follow-up. At any particular time a contact center may be handling multiple campaigns for multiple businesses.

Contact centers may have a first set of equipment and group of agents assigned to one contact campaign and a second set of equipment and group of agents assigned to a second contact campaign. Each campaign may be working independently of the other. Each campaign may include a database of customer contact records. The customer contact records may include, for example, a telephone number or contact information, a name, address, account number, and other information pertaining to the customer transactions. Each campaign may include equipment, as discussed above, to initiate the communication session with the customers listed in the customer contact records stored within the database for the respective campaign. The live customers are then routed to communications equipment of an agent with expertise in the respective campaign. The communications equipment may include, for example, a telephone, a computer, and other equipment used to relay information to and from the agent.

Within a contact center it is possible a customer may be associated with multiple campaigns. The contact center may attempt and successfully reach a customer with regard to a first campaign. However, at a later point in time the contact center may fail to contact the same customer with regard to a second campaign. The different campaigns may function separately with regard to each other. The second outbound campaign may not be aware and will have missed the opportunity to communicate with the customer when the customer was contacted with respect to the first campaign.

Accordingly, a need exists for a device, method, and system for identifying a live customer that may be associated with other campaigns within a contact center or multiple contact centers. The device, method, and system may transfer the customer to the agent associated with the other campaign. The transfer may be accomplished interactively or blindly. In addition to transferring the communication session with the customer, the device, method, and system may also transfer current information associated with the customer to an agent associated with the second campaign.

### SUMMARY

The present invention is a novel device, system, and method for providing the transfer of a communication session from a first communication campaign to a second communication campaign. The first communication campaign may include a first communication initiating device and a first set of agent terminals. The second communication campaign may include a second communication initiating device and a second set of agent terminals. The system places at least one outbound communication to a customer using the first communication initiating device of the first communication campaign. The system connects the outbound communication to an available outbound agent of the first communication campaign. The system determines whether the customer needs to be connected to an outbound agent terminal of the second communication campaign. If the system determines the customer should be contacted by the second communication campaign, the system transfers the customer to the outbound agent of the second communication campaign.

In another embodiment, the system determines a priority level between at least the first communication campaign and the second communication campaign. The system transfers the customer to an agent from the communication campaign with a higher priority level. The system then transfers the customer to the next higher priority outbound campaign after the outbound campaign with the higher priority level has completed communications with the customer.

In another embodiment, the system alerts the customer of the need to connect the customer to the agent of the second outbound campaign. The customer submits a request to be transferred to the agent of the second outbound campaign. In yet another embodiment, the system compares a contact list associated with the first communication campaign to a contact list associated with the second communication campaign. The system identifies common contacts in both contact lists and organizes the contact lists to provide more efficient connection of the common contacts by both the first communication campaign and the second communication campaign.

It is important to note that the present invention is not intended to be limited to a system or method which must satisfy one or more of any stated objects or features of the invention. It is also important to note that the present invention is not limited to the exemplary embodiments described herein. Modifications and substitutions by one of ordinary skill in the art are considered to be within the scope of the present invention, which is not to be limited except by the following claims.

### BRIEF DESCRIPTION OF THE DRAWINGS

These and other features and advantages of the present invention will be better understood by reading the following detailed description, taken together with the drawings wherein:

FIG. 1 is a system diagram of a communication network used to provide campaign and queue cooperation between campaign platforms.

FIG. 2 is a flow chart illustrating a first exemplary embodiment of a method for campaign and queue cooperation between campaign platforms, according to the present invention.

FIG. 3 is a flow chart illustrating a second exemplary embodiment of a method for campaign and queue cooperation between campaign platforms, according to the present invention.

FIG. 4 is a flow chart illustrating a third exemplary embodiment of a method for campaign and queue cooperation between campaign platforms, according to the present invention.

FIG. 5 is a flow chart illustrating a fourth exemplary embodiment of a method for campaign and queue cooperation between campaign platforms, according to the present invention.

### DETAILED DESCRIPTION

The invention provides configurable algorithms and logic that enables a system managing multiple campaigns/queues simultaneously to provide the facilities for these campaigns and queues to exchange information and cooperate to better accomplish the individual tasks.

These campaigns/queues may operate independently according to their own rules and objectives. When a campaign/queue reaches a given customer, it can process the customer and then make that customer available to other campaigns/queues. If that customer was targeted by another outbound campaign, that second campaign could immediately use the contact instead of attempting to reach it as part of its normal processing.

The transfer of a customer can involve providing options to the customer. In one exemplary embodiment, an agent on the first campaign/queue alerts the customer that another campaign/queue has shown interest in reaching it and then asking the customer if it desires to be reached. In another exemplary embodiment, the transfer of a customer can be made blindly; the second campaign may initiate a communication with the customer after the first one is done with the customer. This may be accomplished using the same line of communication or initiating a new line of communication after the prior communication, associated with the first campaign, is terminated. In yet another exemplary embodiment, a second campaign may preempt a communication with a first campaign, a second campaign with a higher priority may utilize a connection with a customer prior to the first campaign that originally contacted the customer.

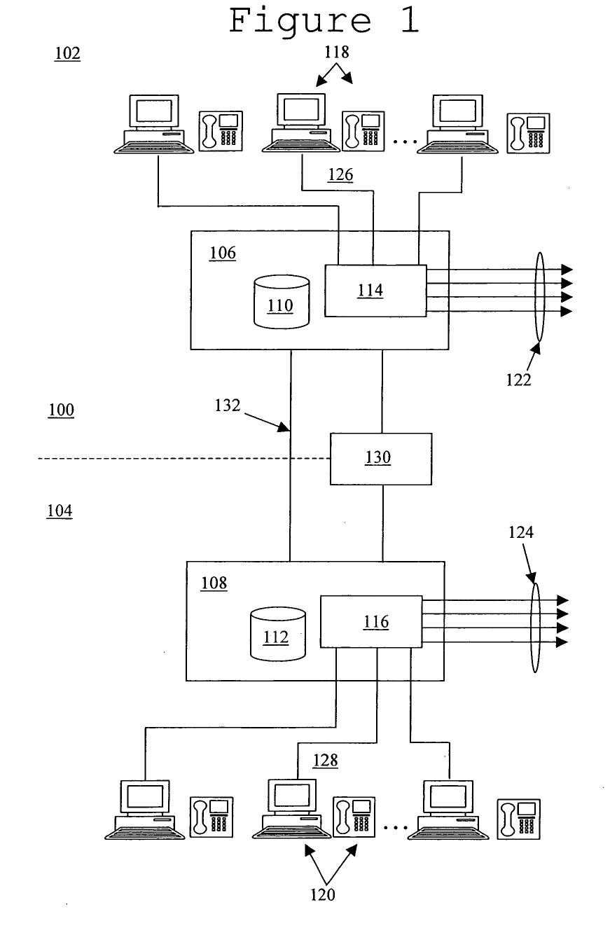

A contact center 100, FIG. 1, provides a communication network used to provide campaign and queue cooperation between campaign platforms. In the exemplary embodiment, a first campaign 102 and a second campaign 104 can be implemented within a contact center 100, such as the type sold under the name Unison® by Concerto Corporation of Westford, Mass. This type of system is described in greater detail in U.S. Pat. No. 5,592,543 issued Jan. 7, 1997 assigned to the assignee of the present application and incorporated herein by reference. The present invention also contemplates using the system and method of the present invention with other types of contact center management systems used to control outbound communications in a contact center, as is known in the art.

The first campaign 102 and the second campaign 104 may each include a host computer 106, 108; a database 110, 112; and a communications initiating device 114, 116. The host computers 106, 108 connect the agent communication terminals 118, 120 to a customer via trunk communication lines 122, 124, respectively. The communications initiating devices 114, 116 access customer contact records that may be stored locally within the database 110, 112 of the respective campaigns 102, 104. When the communications initiating device 114, 116 reaches a busy number or unavailable customer, the communication session may be terminated and contacted again at a later time. When the communications initiating device 114, 116 reaches a live customer, the host computer 106, 108 connects the live customer to an agent communication terminal 118, 120 within a group of agents 126, 128 assigned to the respective campaigns 102, 104. The agent communications terminals 118, 120 may include, for example, a telephone, a computer, and other equipment used to relay information to and from the agent. The agent may then communicate the necessary information to the customer.

A campaign integrator 130 may compare the customer contact record of the live customer of the first campaign 102 with the customer contact records associated with the second campaign 104. When the campaign integrator 130 locates a customer contact record associated with the second campaign 104 that is representative of the same live customer, the campaign integrator 130 may facilitate the transfer of the live customer to an agent associated with the second campaign 104. The transfer of the live customer may be accomplished by a communication link 132 provided between the first campaign 102 and the second campaign 104. The campaign integrator 130 may also provide the agent of the second campaign 104 with access to a transaction record associated with the transaction of the agent associated with the first campaign 102. The search and transfer of the live customer may be provided by various exemplary methods described later herein.

The above exemplary system of the above contact center 100 is for illustrative purposes. The embodiments of the present invention are not limited to the architecture of the exemplary system shown in FIG. 1. Embodiment of the invention may be implemented in a variety of contact center architectures. For example, a contact center may have one host computer, one database and one communication initiating device that support multiple independent campaigns. The campaign integrator may be implemented within the host computer allowing the host computer, currently operating independent campaigns, to blend mutual customers of the independent campaigns. This contact center architecture, as well as other contact center architectures, are within the scope of the present invention.

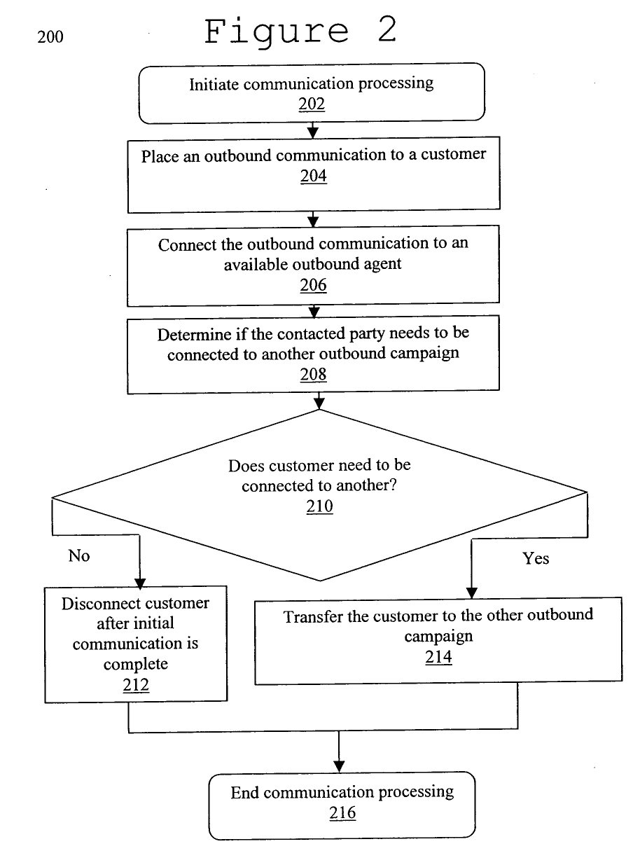

A flow chart illustrating a first exemplary embodiment 200 of the invention, shown in FIG. 2, enables a system managing multiple campaigns/queues simultaneously to transfer a live customer to agents associated with the other campaigns. The host computer for the first campaign initiates the communication process (block 202). The communication initiating device receives the customer contact record for the next intended customer. The communication initiating device places an outbound communication to the customer (block 204). Once a live customer is contacted by the communication initiating device, the customer is transferred to an agent associated with the first campaign (block 206). The system searches the customer contact records associated with a second campaign to determine if the current live customer is scheduled to be contacted by the second campaign (block 208). The search may be performed using a variety of database search algorithms known to an individual skilled in the art.

If the system determines that the customer does not need to be contacted by the second campaign (“No” branch of block 210), the customer is disconnected after the communication with the first campaign is complete (block 212). The system ends the communication processing and prepares for the next customer communication (block 216). If the system determines that the customer does need to be contacted by the second campaign (“Yes” branch of block 210), the customer is transferred to the next available agent from the second campaign after the communication with the first campaign is complete (block 214). The transfer of the customer to the second agent can be accomplished in a variety of manners as discussed later herein. Once the customer is transferred to an agent associated with the second campaign, the system ends the communication processing and prepares for the next customer communication (block 216).

The first exemplary embodiment 200, as well as other exemplary embodiments herein, illustrate the transfer of a customer from a first campaign to a second campaign. One skilled in the art will appreciate that the search and transfer may occur in both directions. For example, a customer that is contacted with regard to a second campaign and also determined to be associated with a first campaign may be transferred to an agent of the first campaign after the communication with the second campaign is completed.

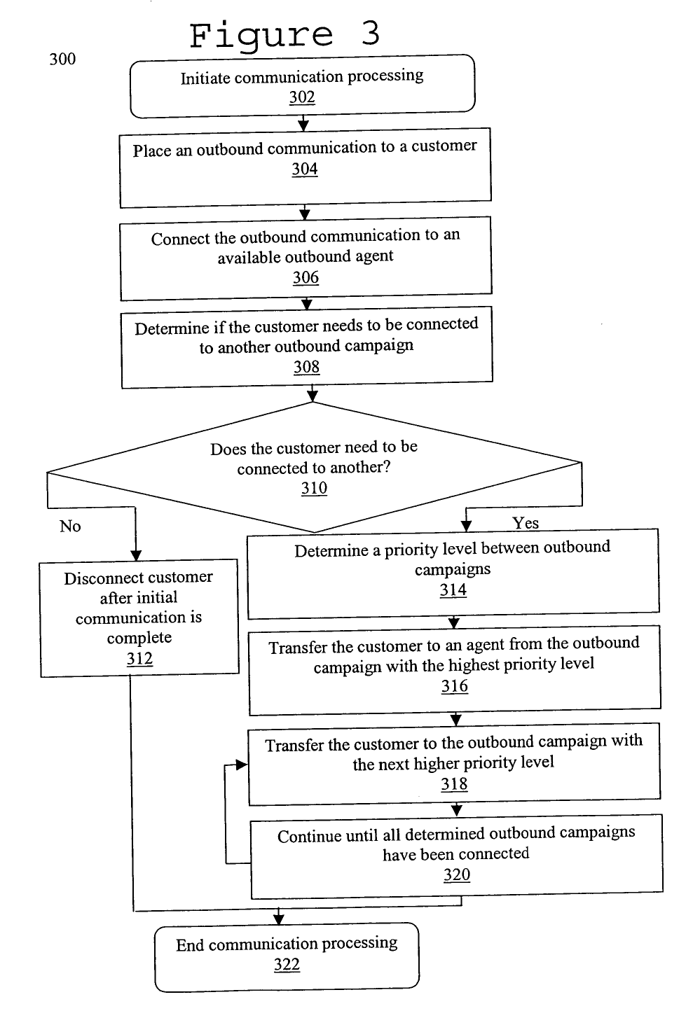

A flow chart illustrating a second exemplary embodiment 300 of the invention, shown in FIG. 3, enables a system to preempt a communication with a first campaign and transfer the customer to a second campaign with a higher priority. The host computer for the first campaign initiates the communication process (block 302). The communication initiating device receives the customer contact record for the next intended contact. The communication initiating device places an outbound communication to the customer (block 304). Once a live customer is contacted by the communication initiating device, the system searches the customer contact records associated with a second campaign to determine if the current live customer is scheduled to be contacted by the second campaign (block 308). The search may be performed using a variety of database search algorithms known to an individual skilled in the art.

If the system determines that the customer does not need to be contacted by the second campaign (“No” branch of block 310), the customer is disconnected after the communication with the first campaign is complete (block 312). The system ends the communication processing and prepares for the next customer communication (block 322). If the system determines that the customer does need to be contacted by the second campaign (“Yes” branch of block 310), the system determines the priority level of each campaign that includes the live customer within the respective campaign (block 314). Priority level may be predefined for each respective campaign. For example, a campaign for customer follow-up may have a higher priority relative to a campaign to inform customers of a new product release. The priority may also take into account current campaign status, for example, if the first campaign currently has no available agents, the second campaign may be given a higher priority relative to the first campaign.

The customer may be transferred to the campaign with the highest priority level (block 316). The customer is transferred to the next available agent from the campaign with the next highest priority after the communication with the previous campaign is complete (block 318). The transfer of the customer to the agent can be accomplished in a variety of manners as discussed later herein. The system may continue to transfer the customer to campaigns until all outbound campaigns have been connected to the customer (block 320). Once the customer has been transferred to all the requested campaigns, the system ends the communication processing and prepares for the next customer communication (block 322).

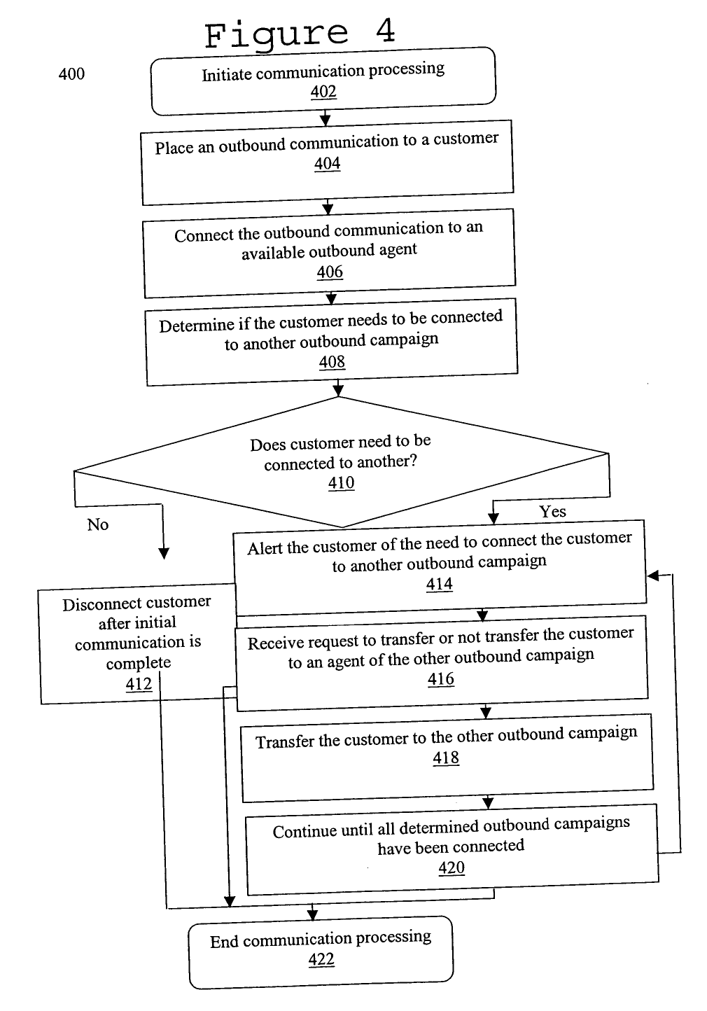

A flow chart illustrating a third exemplary embodiment 400 of the invention, shown in FIG. 4, enables a system to provide transfer options to the customer. The host computer for the first campaign initiates the communication process (block 402). The communication initiating device receives the customer contact record for the next intended contact. The communication initiating device places an outbound communication to the customer (block 404). Once a live customer is contacted by the communication initiating device, the system searches the customer contact records associated with a second campaign to determine if the current live customer is scheduled to be contacted by the second campaign (block 408). The search may be performed using a variety of database search algorithms known to an individual skilled in the art.

If the system determines that the customer does not need to be contacted by the second campaign (“No” branch of block 410), the customer is disconnected after the communication with the first campaign is complete (block 412). The system ends the communication processing and prepares for the next customer communication (block 422). If the system determines that the customer does need to be contacted by the second campaign (“Yes” branch of block 410), the system alerts the customer of the desire to connect the customer to another outbound campaign (block 414). The system may alert the customer in a variety of manners.

For example, but not limited to, the system may display the request on a monitor at the agent's terminal. After the agent has completed the communication with regard to the first campaign, the agent may personally inform the customer of the opportunity provided by the second campaign. If the customer requests the transfer, the agent may conference with an agent from the other campaign and transfer the customer to the other agent.

In yet another example, an automated audio prompt may inform the customer of the other campaign after the first campaign is complete. If the customer wishes to be transferred, the customer may respond to a voice recognition system or a touch-tone response system. The system will then transfer the customer to an agent associated with the second campaign.

The system receives the request from the customer to transfer or not transfer (block 416). If the customer does not wish to be transferred, the system ends the communication processing and prepares for the next customer communication (block 422). If the customer does wish to be transferred, the customer is transferred to the next available agent from the other campaign (block 418). The system may continue to request permission to transfer the customer to other campaigns until all outbound campaigns associated with the customer have been connected to the customer (block 420). Once the customer has been transferred to all the requested campaigns or no longer requests to be transferred, the system ends the communication processing and prepares for the next customer communication (block 422).

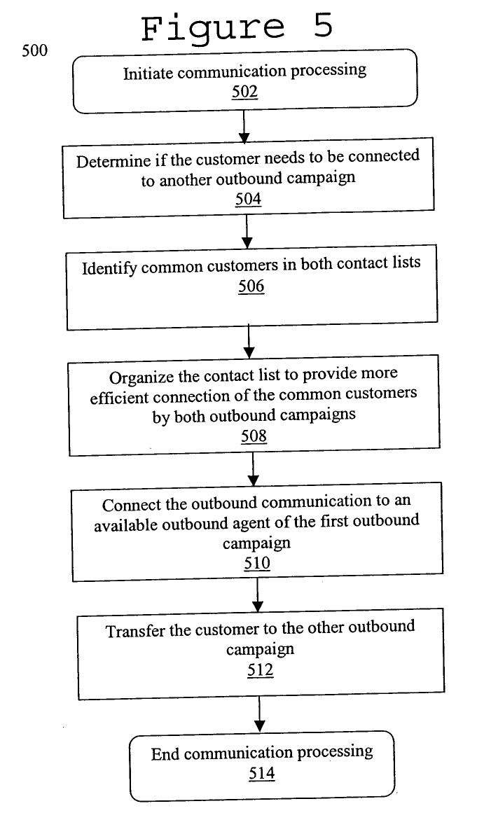

A flow chart illustrating a fourth exemplary embodiment 500 of the invention, shown in FIG. 5, enables a system to arrange customers that are associated with multiple campaigns in an efficient manner for contact. The system initiates the communication process (block 502). The system determines if the customer needs to be contacted by multiple campaigns (block 504). The system identifies the common customers associated with multiple campaigns (block 506).

The system organizes the order of contacting customers for each campaign based on the common customers (block 508). The system may organize the order of contacting customers in a variety of manners based on a variety of conditions. For example, the system may appropriately space the attempts to contact common customers between the multiple campaigns, so that one campaign is not always contacting a customer first or overloading another campaign with transferred customers. In another example, a first campaign may start prior to a second campaign and the first campaign may end prior to the ending of a second campaign. The system may organize the common customers to be contacted after the start of the second campaign but prior to the conclusion of the first campaign. In another example, the system may select specific agents skilled to handle both a first campaign and a second campaign to handle customers common to both campaigns.

Once the contact order is organized by the system for each campaign, the system connects the customer to an available agent of the first campaign (block 510). After the communication is complete with the first campaign, the customer is transferred to the second campaign (block 512). After the customer has been transferred to all the requested campaigns, the system ends the communication processing and prepares for the next communication session (block 514).

The exemplary embodiments described herein may be associated with the processor and memory associated with the campaign integrator or host computer for the campaigns. However, the aspects described in the exemplary embodiments may be implemented in a variety of digital electronic circuitry, or in computer hardware, firmware, software, or in combinations of them. The exemplary embodiments described herein can be implemented as a computer program product, i.e., a computer program tangibly embodied in an information carrier, e.g., in a machine-readable storage device or in a propagated signal, for execution by, or to control the operation of, a communications processing apparatus, e.g., a processing device, a computer, or multiple computers. A computer program can be written in any form of programming language, including compiled, assembled, or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

The present invention is not intended to be limited to a system, device, or method which must satisfy one or more of any stated or implied object or feature of the invention and is not limited to the exemplary embodiments described herein. Modifications and substitutions by one of ordinary skill in the art are considered to be within the scope of the present invention.

The invention claimed is:

1. A method of transferring a communication session from a first outbound campaign to a second outbound campaign, the first outbound campaign including a first communication initiating device and a first set of a plurality of agent communication terminals, and the second outbound campaign including a second communication initiating device and a second set of a plurality of agent communication terminals, said method comprising:
placing at least one outbound communication to a customer using the first communication initiating device of the first outbound campaign;
connecting the outbound communication to an available outbound agent at one of said agent communication terminals of the first outbound campaign;
determining that the customer needs to be connected to an agent communication terminal of the second outbound campaign; and
transferring the customer to the agent communication terminal of the second outbound campaign.

2. The method of claim 1 wherein the action of determining involves searching a contact list associated with the second outbound campaign for the customer of the first outbound campaign when the customer is successfully contacted.

3. The method of claim 1 wherein the action of determining involves searching a contact list associated with the second outbound campaign for the customer of the first outbound campaign when the first outbound campaign initiates connection to the customer.

4. The method of claim 1 wherein the action of determining involves searching a contact list associated with the second outbound campaign for the customer of the first outbound campaign when the first outbound campaign has completed communications with the customer.

5. The method of claim 1 further including:
determining a priority level between at least said first outbound campaign and said second outbound campaign,
transferring the customer to an agent from the outbound campaign with a higher priority level, and
transferring the customer to the next higher priority outbound campaign after the outbound campaign with the higher priority level has completed communications with the customer.

6. The method of claim 1 wherein the action of transferring the customer to the outbound agent terminal of the second outbound campaign involves conferencing the customer, an agent of the first outbound campaign, and an agent of the second outbound campaign.

7. The method of claim 1 wherein the action of transferring the customer to the agent communication terminal of the second outbound campaign further comprises:
alerting the customer of the need to connect the customer to an agent of the second outbound campaign and
requesting by the customer to transfer the customer to the agent of the second outbound campaign.

8. The method of claim 1 wherein the action of transferring the customer to the agent communication terminal of the second outbound campaign further comprises:
disconnecting the customer from an agent of the first outbound campaign;
placing at least one outbound communication to the customer soon after the action of disconnecting using the second communication initiating device of the second outbound campaign; and
connecting the outbound communication to an available outbound agent at one of said agent communication terminals of the second outbound campaign.

9. The method of claim 1 wherein the action of determining further comprises:
comparing a contact list associated with the first outbound campaign to a contact list associated with second outbound campaign,
identifying common contacts in both contact lists, and
organizing the contact lists to provide more efficient connection of the common contacts by both the first outbound campaign and the second outbound campaign.

10. A system for transferring a communication session from a first outbound campaign to a second outbound campaign, said system comprising:
the first outbound campaign including a first communication initiating device and a first set of a plurality of agent communication terminals wherein the first communication initiating device of the first communication campaign places at least one outbound communication to a customer and a host computer of the first outbound campaign connects the outbound communication to an available outbound agent at one of said agent communication terminals of the first outbound campaign;
the second outbound campaign including a second communication initiating device and a second set of a plurality of agent communication terminals; and
a campaign integrator to determine if the customer needs to be connected to an agent communication terminal of the second outbound campaign and transfer the customer to the agent communication terminal of the second outbound campaign.

11. The system of claim 10 wherein the campaign integrator determines a priority level between at least said first outbound campaign and said second outbound campaign, transfers the customer to an agent from the outbound campaign with a higher priority level, and transfers the customer to the next higher priority outbound campaign after the outbound campaign with the higher priority level has completed communications with the customer.

12. The system of claim 10 wherein the campaign integrator transferring the customer to the outbound agent terminal of the second outbound campaign involves conferencing the customer, an agent of the first outbound campaign, and an agent of the second outbound campaign.

13. The system of claim 10 wherein the campaign integrator further comprises a module to alert the customer of the need to connect the customer to an agent of the second outbound campaign and a module to receive a request by the customer to transfer the customer to the agent of the second outbound campaign.

14. The system of claim 10, further comprising;
a module to disconnect the customer with an agent of the first outbound campaign;
a module to place at least one outbound communication to the customer soon after the action of disconnecting using the second communication initiating device of the second outbound campaign; and
a module to connect the outbound communication to an available outbound agent at one of said agent communication terminals of the second outbound campaign.

15. The system of claim 10 wherein the campaign integrator further comprises a module to compare a contact list associated with the first outbound campaign to a contact list associated with the second outbound campaign, a module to identify common contacts in both contact lists, and a module to organize the contact lists to provide more efficient connection of the common contacts by both the first outbound campaign and the second outbound campaign.

16. A computer program product, tangibly embodied in an information carrier, for transferring a communication session from a first outbound campaign to a second outbound campaign, the first outbound campaign including a first communication initiating device and a first set of a plurality of outbound agent terminals, and the second outbound campaign including a second communication initiating device and a second set of a plurality of outbound agent terminals, the computer program product being operable to cause a machine to:
place at least one outbound communication to a customer using the first communication initiating device of the first communication campaign;
connect the outbound telephone communication to an available outbound agent at one of said outbound agent terminals of the first outbound campaign;
determine that the contacted party needs to be connected to an outbound agent terminal of the second outbound campaign; and
transfer the customer to the outbound agent terminal of the second outbound campaign.

17. The computer program product of claim 16, further comprising the computer program product being operable to cause a machine to:
determine a priority level between at least said first outbound campaign and said second outbound campaign,
transfer the customer to an agent from the outbound campaign with a higher priority level, and
transfer the customer to the next higher priority outbound campaign after the outbound campaign with the higher priority level has completed communications with the customer.

18. The computer program product of claim 16, further comprising the computer program product being operable to cause a machine to:
disconnect the customer with an agent of the first outbound campaign;
place at least one outbound communication to the customer soon after the action of disconnecting using the second communication initiating device of the second outbound campaign; and
connect the outbound communication to an available outbound agent at one of said agent communication terminals of the second outbound campaign.

19. The computer program product of claim 16, further comprising the computer program product being operable to cause a machine to:
compare a contact list associated with the first outbound campaign to a contact list associated with the second outbound campaign,
identify common contacts in both contact lists, and organize the contact lists to provide more efficient connection of the common contacts by both the first outbound campaign and the second outbound campaign.
